(19) United States
(12) Patent Application Publication
(10) Pub. No.: US 2005/0256240 A1
(43) Pub. Date: Nov. 17, 2005

(54) Nanometric composites as improved dielectric structures

(75) Inventor: J. Keith Nelson, Niskayuna, NY (US)

Correspondence Address: NOTARO AND MICHALOS, 100 DUTCH HILL ROAD, SUITE 110, ORANGEBURG, NY, 10962-2100, US

(73) Assignee: Rensselaer Polytechnic Institute, Troy, NY (US)

(21) Appl. No.: 10/526,949

(22) PCT Filed: Oct. 3, 2003
(86) PCT No.: PCT/US03/31465

§ 371 Date: Mar. 8, 2005

Related U.S. Application Data
(60) Provisional application No. 60/415,987, filed on Oct. 4, 2002.

(51) Int. Cl. C08K 3/18

(52) U.S. Cl. 524/430

(57) ABSTRACT

A dielectric is provided which possesses high dielectric constant and high dielectric strength, while having the ca-pabilities of a polymer. The dielectric comprises a nanometric composite, which includes a stoichiometric nano-particulate filler embedded in a polymer or resin matrix. Filler particles are reduced in physical size to dimension to the same order as the polymer chain length of the host material and interact cooperatively thereby mitigating the associated Maxwell-Wagner process and reducing interfacial polarization. The internal fields for the new formulation are nearly a factor of 10 lower then for conventional (micro) material. The large changes in the internal field of the composite permit engineering of nanocomposite materials with enhanced electric strength and improved voltage endurance properties.

### FIELD AND BACKGROUND OF THE INVENTION

The present invention relates generally to the field of nanometric composites and in particular to a new and useful dielectric structure comprising nanometric composites.

Electrical insulation is a pervasive technology which is a huge commercial business ranging from the thin films used in the microelectronics industry to the large amounts of material used to insulated high-voltage equipment in the power segment of this market. In most instances, the dielectric properties of the insulating structure limits the design. A 20% improvement in performance would thus have significant industrial significance and so the substantial changes that are indicated by this disclosure are believed to be commercially important.

Polymers of many types are commonly used as electrical insulation. The use of conventional fillers for polymer materials is well known and is usually employed to reduce the cost of a material or to modify one of the material properties for a particular application, such as discharge resistance, thermal expansion, etc. Often the use of such fillers will affect electrical properties, dielectric strength and loss in a negative way. In this context, it is thought that fundamental to controlling the dielectric strength of insulating polymers is the cohesive energy density and the associated free volume of a polymer structure, as suggested in Sabuni H. and Nelson J. K., “Factors determining the electric strength of polymeric dielectrics”, J. Mats Sci., Vol. 11, p 1574, 1976 and Nelson J. K., “Breakdown strength of solids”, Engineering Dielectrics, Vol. 2A, ASTM, 1993. This may be gauged by examining the changes in electric strength (up to a factor of 10) exhibited by most polymers as they are taken through their glass transition temperature.

Nanoparticles are fundamental building blocks in the design and creation of assembled nano-grained larger scale structures with excellent compositional and interfacial flexibility. However, rather surprisingly, the current push to develop nanomaterials based on nanotechnology has not focused much on the opportunities for dielectric materials, but rather centered on optical and mechanical applications, as disclosed in U.S. Pat. Nos. 5,433,906, 5,462,903, 6,344,271, and 6,498,208.

Nonetheless, the few examples in the literature provide encouragement that this is likely to be fertile ground. Furthermore, some theoretical reasons for pursuing nanomaterials as a basis for dielectric applications have been reviewed by Lewis T. J., “Nanometric Dielectrics”, IEEE Trans on Diel. And Elect. Ins., Vol. 1, pp 812-25, 1994 and Frechette M. F. et al., “Introductory remarks on NanoDielectrics”, Ann. Rep. Conf. On Elect. Ins. And Diel. Phen., IEEE, pp 92-99, 2001.

Several patents have also disclosed nanocomposites for altering electrical properties. U.S. Pat. No. 6,228,904 discloses a nanocomposite structure comprising a nanostructured filler or carrier intimately mixed with the matrix, which is preferably polymeric. The nanostructured filler can alter certain electrical properties by at least 20%. The patent further discloses oxide ceramic nanofiller compositions such as TiO₂ and dielectrics. Nanocomposites with modified internal charge and improved dielectric strength and voltage endurance are not disclosed. Instead, the focus is on the creation of linear and non-linear conductivity in host materials

U.S. Pat. Nos. 6,554,609 and 6,607,821, which are divisional patents of the same parent patent, disclose nano-structured non-equilibrium, non-stoichiometric materials and electrical devices. For example, non-stoichiometric titania in the form of TiO_{1.8} or TiO_{1.3} is taught, as opposed to stoichiometric titania TiO₂. The patents teach that such nanostructured non-stoichiometric can change the electrical properties of a material such as electrical conductivity, dielectric constant, dielectric strength, dielectric loss, and polarization, and are preferred over stoichiometric titania.

U.S. Pat. No. 6,599,631 discloses the use of polymer/inorganic particle composites in forming electric and electro-optical devices. However, the '631 patent teaches inorganic nano-particle/polymer composites in which the elements of the composite are chemically bonded. Furthermore, although such composites are disclosed as particularly useful for the formation of devices with a selected dielectric constant/index-of-refraction, the focus of the patent is on electro-optical properties rather than dielectric properties as related to insulation. Appropriate selection of index-of-refraction can be important for the preparation of either electrical or optical materials. The index-of-refraction is approximately the square root of the dielectric constant when there is no optical loss, so that the engineering of the index-of-refraction corresponds to the engineering of the dielectric-constant. Thus, the index-of-refraction/dielectric constant is related to both the optical and electrical response of a particular material. Index-of-refraction engineering can be especially advantageous in the design of optical or electrical interconnects.

The behavior of a typical composite material is often controlled by the properties of the matrix, the distribution and properties of the filler as well as the nature of their interface. Conventional fillers are micron size and have been shown to act as foreign bodies, as opposed to cooperative bodies, exerting influence on the resident material via interfacial properties. In the simplest situation, the bonding of a polymer to a filler can be expected to give a layer of “immobilized” polymer. The size of this layer is critical to the global properties (electrical, mechanical and thermal) of the composite. However, the in-filled material will give rise to space-charge accumulation and an associated Maxwell-Wagner polarization due to the implanted interfaces.

Furthermore, macroscopic theories of interfacial polarization do not incorporate a molecular approach since the response is given by relaxation equations if the wavelength is large in comparison with molecular dimensions. In considering pre-breakdown high-field conduction in pure materials, the existence of localized states within the energy band gap (close to the conduction or valence bands) is usually invoked, giving rise to a mobility edge for electron (or hole) transport. These states are essentially localized on individual molecules. This is because, unlike the strong covalent bonds of elemental crystalline solids, intermolecular binding arises from weak van der Waals' forces that do not allow inter-molecular electronic exchange.

A molecular approach is needed for enhancing the dielectric properties of insulating structures. Stoichiometric composites are needed in which filler particles behave cooperatively with the host matrix rather than as foreign bodies. Furthermore, composites are needed where space-charge accumulation and internal fields are reduced and associated Maxwell-Wagner polarization due to implanted interfaces is mitigated.

### SUMMARY OF THE INVENTION

It is an object of the present invention to provide a nanometric composite in which internal fields are reduced by a factor up to 10 from conventional composites, and the associated Maxwell-Wagner interfacial polarization is mitigated.

It is a further object of the present invention to provide a nanometric composite in which filler particles behave cooperatively with the matrix of the composite thereby mitigating the associated Maxwell-Wagner process and reducing interfacial polarization.

Accordingly, a nanometric composite is provided for dielectric structure applications, and comprises nano-particulate fillers embedded in a matrix of polymer or resin. The polymer is essentially any commercially available polymer.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 are two graphs plotting permittivity and loss tangent as a function of temperature and frequency for the micro-particulate filled composites;

FIG. 2 are two graphs plotting permittivity and loss tangent as a function of temperature and frequency for the nano-particulate filled composites;

FIG. 3 is a graph showing the initial distribution of an electric field based on an electroacoustic study of nano-filled composites;

FIG. 4 is a graph based on the pulsed electroacoustic study of the composite with the micron-sized filler;

FIG. 5 is a graph based on the pulsed electroacoustic study of the composite with the nano-sized filler;

FIG. 6 is a graph showing charge migration in a 10% microfilled TiO₂ sample;

FIG. 7 is a graph showing electroluminescene characteristics in TiO₂ composites for base resin, 10% micro filler resin and, 10% nano filler resin;

FIG. 8 is a graph showing electroluminescence onset field as a function of TiO₂ loading for the 38 nm sample and the 1.5 μm sample composites;

FIG. 9a is a graph showing dynamics of electroluminescence in response to step changes in electric field for the 38 nm TiO₂ sample;

FIG. 9b is a graph showing dynamics of electroluminescence in response to step changes in electric field for the 1. 5 μm TiO₂ sample;

FIG. 10 is a graph showing thermally stimulated current spectra for the 10% 38 nm TiO₂ sample, and the 10% 1.5 μm TiO₂ sample;

FIG. 11 is a graph showing electric strength of Epoxy/TiO₂ composites for the 38 nm filler sample and the 1.5 μm filler sample; and

FIG. 12 is a graph of composite breakdown statistics plotted as a Weibull distribution for the micro filler sample, nano filler sample and base resin sample.

### DESCRIPTION OF THE PREFERRED EMBODIMENTS

A composite dielectric of the present invention possesses high dielectric strength, while having the capabilities of a polymer. The composite also may have high dielectric constant if fillers are chosen which have a high dielectric constant. The composite includes stoichiometric nano-particulate filler embedded in a matrix of polymer or resin. The filler particles have a physical size of the same order as the polymer chain length of the host material and interact cooperatively thereby mitigating the associated Maxwell-Wagner process and reducing interfacial polarization. The internal fields for the new formulation are nearly a factor of 10 lower then for conventional (micro) material.

The large changes in the internal field of the composite permit engineering of nanocomposite materials with enhanced electric strength and improved voltage endurance properties. The composition and physical configuration of the dielectric can be designed to specific application requirements such as high voltage insulation or electrical field grading.

In a preferred embodiment of the present invention, the composite includes 10% inorganic oxide in the form of Titanium Dioxide (TiO₂) filler particulates with nano dimensions embedded in a Bisphenol-A epoxy (Vantico CY1300+HY956) polymer. Bisphenol-A epoxy is a preferred polymer because it is benign (i.e. without other fillers or dilutents), it has a low initial viscosity, and has a glass transition below 100° C.

However, the invention is not limited to titanium dioxide as filler and can include a broad range of inorganic oxides, metal oxides, titanates, silicas, particles coated with coupling agents such as silanes and triblock copolymers, and even nano-sized polymers. Silica-based fillers in particular are suitable due to their low loss characteristics. The availability of nanoparticles of a wide range of inorganic oxides offers the possibility of creating a range of new materials with tailored properties and benefits (e.g. variation in relative permittivity and linearity).

Still, the invention is not limited to the broad range of filler groups which have been disclosed since they are only mentioned as examples in order to enable one to practice the invention. In practice, one of ordinary skill in the art will understand that a variety of different fillers can be used based on the application that is desired. Aluminum oxide may be preferred because it is inexpensive or zinc oxide may be used because of its non-linear nature.

If a dielectric with high dielectric constant is desired, nanocomposites with fillers having high dielectric constant may be used such as Titanium Dioxide. Conventional filler materials include the oxides of aluminum, zinc, and titanium. Aluminum oxide has a linear current versus voltage relationship and is widely in use. Conversely, zinc oxide is highly non-linear. Titanium dioxide however, is an attractive material due to its inherently high dielectric constant of 90-100 versus aluminum oxide and zinc oxide both of which are in the 6 to 7 range.

The invention is also not limited to Bisphenol-A matrix polymer. The matrix polymer may be a thermoplastic or a thermoset polymer. Other suitable polymers include other variants of epoxy, polyolefins such as low density polyethylene (LDPE), cross-linked polyethylene, and polypropylene. Polypropylene in particular is economically inexpensive and typically used in the capacitor industry. Additionally, the matrix polymer may include ethylene propylene rubber, functionalized polymers such as polyetherimide, and essentially any other commercially available polymer, provided that the filler is available in nano-particulate size.

As applied to the formation of dielectric structures, Example 1 below will illustrate that 10% appears to be the optimum loading % of filler for the configurations tested. Measurements have been made up to 40%, but at that level the mechanical properties are degraded to the point that the material is of little use in such applications. However if the nanophase particles are polymeric, such as for example nano-particulate polyurethane, then 40% loading % of filler may be suitable. For oxides, the loading % ranges between about 2 and about 20% for suitability with dielectric applications.

Example 1 below demonstrates through a variety of studies that significant interfacial polarization associated with conventional fillers, is mitigated in the case of particulates of nanometric size. The studies include Differential Scanning Calorimetry (DSC), Photoluminescence measurements, Dielectric Spectroscopy, Space Charge Assessment via a Pulsed Electro-Acoustic (PEA) apparatus, Electroluminescence, Thermally Stimulated Currents, and Electrical Strength Measurements.

### EXAMPLE 1

Composites were provided for micro-particulates and nano-particulates of Titanium Dioxide embedded in a resin matrix of Bisphenol-A epoxy. A list of the composites is shown below in Table 1.

Test samples of the composites were formed by molding between polished surfaces, held apart by spacers, as described in Griseri V., “The effects of high electric fields on an epoxy resin”, Ph.D. Thesis, University of Leicester, 2000. The molded films range in thickness between 500 and 750 μm. The weighed resin and hardener were degassed at 35° C. and the relevant dried particulate fill was incorporated into the resin by mechanical stirring. Due to their small size, surface interactions for nanoparticles, such as hydrogen bonding, become magnified. This means that the particles tend to agglomerate and dispersion in resins is quite difficult, even in polymers that should be relatively compatible. Hence, in the case of nano-particles, large shear forces are needed in the mixing process to obviate unwanted clustering of the particles. For most electrical characterization, the cast film was provided with evaporated 100 nm aluminum electrodes.

Differential Scanning Calorimetry (DSC)

A Stanton Redcroft DSC 1500 calorimeter was used to thermally characterize the materials. Results on the determination of glass transition temperatures are provided in Table 1 below for post-cured samples from which it is evident that the nano-material reduces T_{g} in contrast to the larger size particles that have the opposite effect. This suggests that particles of nanometric dimensions behave in a similar way to infiltered plasticizers, rather than as “foreign” materials creating a macroscopic interface.

TABLE 1

| Material + Filler | Size (nm) | Loading (%) | Tg(° C.) |
|---|---|---|---|
| CY1300 Resin | N/A | N/A | 63.8 |
| CY1300 + TiO₂ | Micro (1500) | 1 | 76.1 |
| CY1300 + TiO₂ | Micro (1500) | 10 | 73.9 |
| CY1300 + TiO₂ | Micro (1500) | 50 | 79.9 |
| CY1300 + TiO₂ | Nano (38) | 1 | 62.9 |
| CY1300 + TiO₂ | Nano (38) | 10 | 52.4 |
| CYl300 + TiO₂ | Nano (38) | 50 | 62.1 |

Photoluminescence Laminar molded specimens using both micro- and nano-particulates were subjected to photoluminescence measurements as depicted in Table 2 below. for excitation wavelengths from 280 to 360 nm. The shift in the peak wavelength in the presence of the nanoparticles (6^{th} column in Table 2) implies that the emitting species have had their environment altered. On the assumption that the emission is excimeric in origin, this suggests that the nanoparticles may cause minor conformational changes sufficient to bind the excimer units more tightly. The magnitude of the peak emission in the nano-composite case is also behaving in an entirely different way (decreasing with increasing excitation wavelength) when compared with the response of the conventional micron-sized filler.

TABLE 2

| Ex. λ | Base Resin | | 10% Micro | | 10% Nano | |
|---|---|---|---|---|---|---|
| (nm) | Pk λ | Pk Mag | Pk λ | Pk Mag | Pk λ | Pk Mag |
| 280 | 413 | 7.0 | 411 | 25.5 | 418 | 29.6 |
| 320 | 409 | 21.5 | 411 | 35.8 | 420 | 44.6 |
| 340 | 407 | 65.4 | 405 | 128.1 | 412 | 35.2 |
| 360 | 408 | 85.8 | 406 | 151.2 | 423 | 14.1 |

Dielectric Spectroscopy Some insight into the way that the incorporation of materials on nanometric dimensions affect the dielectric properties may be obtained by examining the variation of the real and imaginary components of relative permittivity as a function of temperature and frequency, wherein the temperatures from bottom to top are 293 K, 318 K, 343 K, 368 K, and 393 K. This has been done for the TiO₂ material using a Solartron H. F. frequency response analyzer (Type 1255) in combination with a Solatron Dielectric Interface, Type 1296.

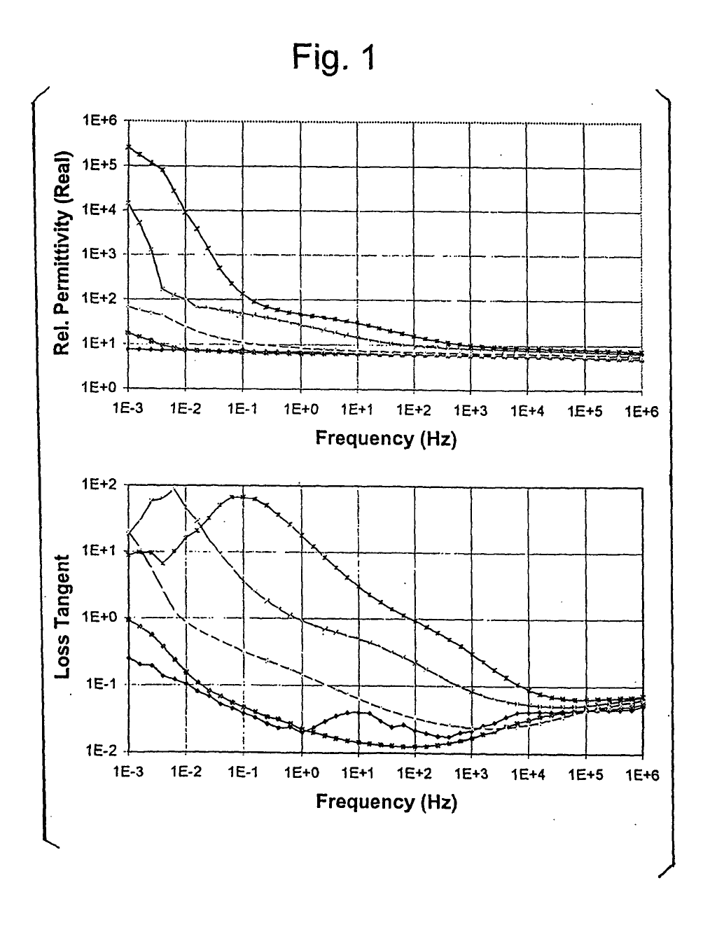

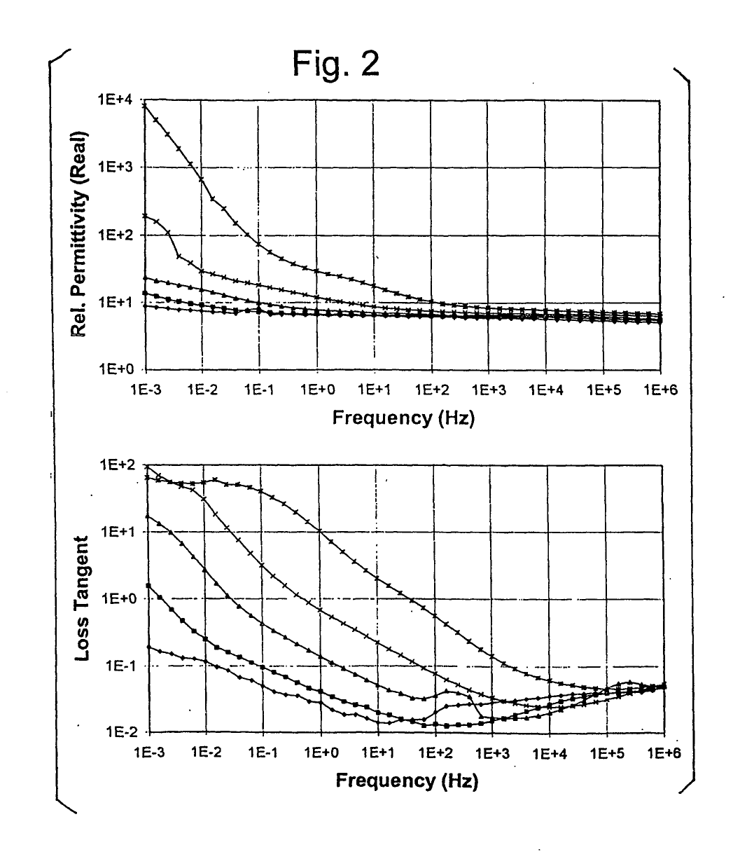

Examples for the micro- and nano-filled materials are shown in FIGS. 1 and 2 respectively. At a nominal 10% (weight percent) particulate loading, the spectra of the resin when filled with particles of micron size (1.5 μm) are virtually indistinguishable from the base resin. This suggests that the low frequency process is probably associated with charges at the electrodes and not due to particulates in the bulk.

With the filler replaced with 10% of nanometric size TiO₂ (38 nm average diameter measured by TEM), the main differences seen relate to a marked modification of the process seen in the base resin at low frequencies and high temperatures. For the nanometric material the process exhibits a flat tan δ response at low frequencies in marked contrast to the micron-sized filler. This suggests that a percolation conduction process is operative. In the presence of the nano-filler, the mid frequency dispersion is noticeably reduced.

The nano materials are clearly inhibiting motion (see PEA results below). The mid-frequency process shows a small change in estimated activation energy from 1.7 eV to 1.4 eV. The magnitude of this process is reduced in the case of nanoparticles since the side chains responsible for the mid-frequency dispersion bind to the particle surface.

Reduction of the particulate loading from 10 to 1% (by weight) did not have any very obvious fundamental changes, but the nano-filled material then does start to exhibit a low frequency response more typical of the base resin and micro-filled material, suggesting that changes engineered by the nanomaterials do require loadings greater than a few percent.

Space Charge Assessment

In order to determine whether nanomaterials function cooperatively as opposed to providing sites for interfacial polarization, a Pulse ElectroAcoustic (PEA) study has also been conducted to assess the field distortions in the bulk. The method has been described in Alison J., “A High Field Pulsed Electro-Acoustic Apparatus for Space Charge and External Circuit Current Measurement within Solid Dielectrics”, Meas. Sci Technol., Vol. 9, pp 1737-50, 1998.

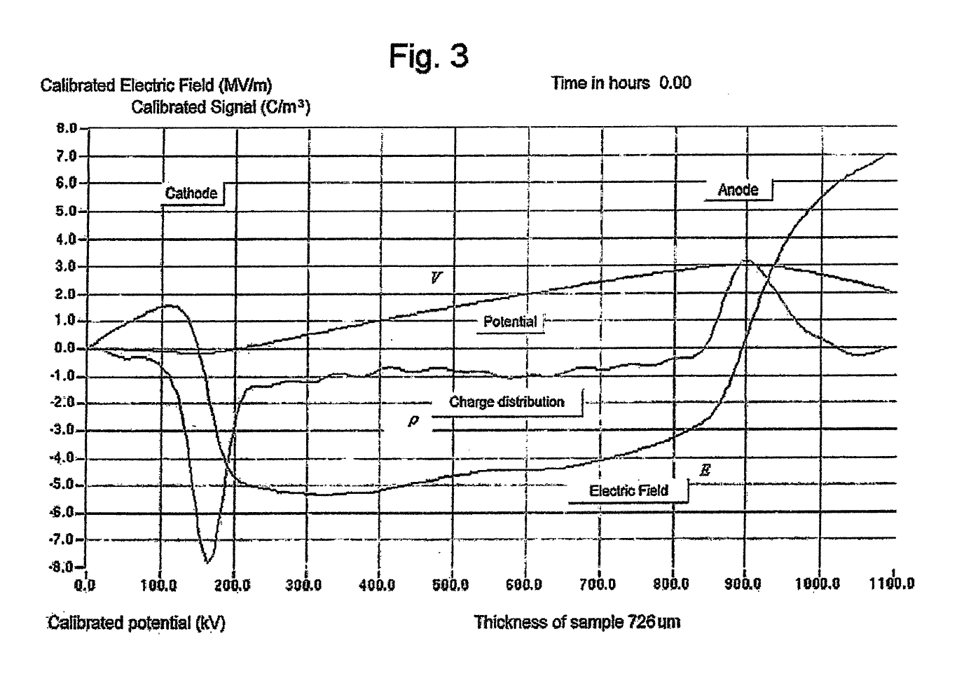

FIGS. 3, 4, and 5 show the results of the electroacoustic study. The figures are labeled with Voltage, V (kV), charge, ρ (C.m⁻³), and electric field, E (kV.mm⁻¹). The double headed arrow indicates the 726 micron thickness of the sample.

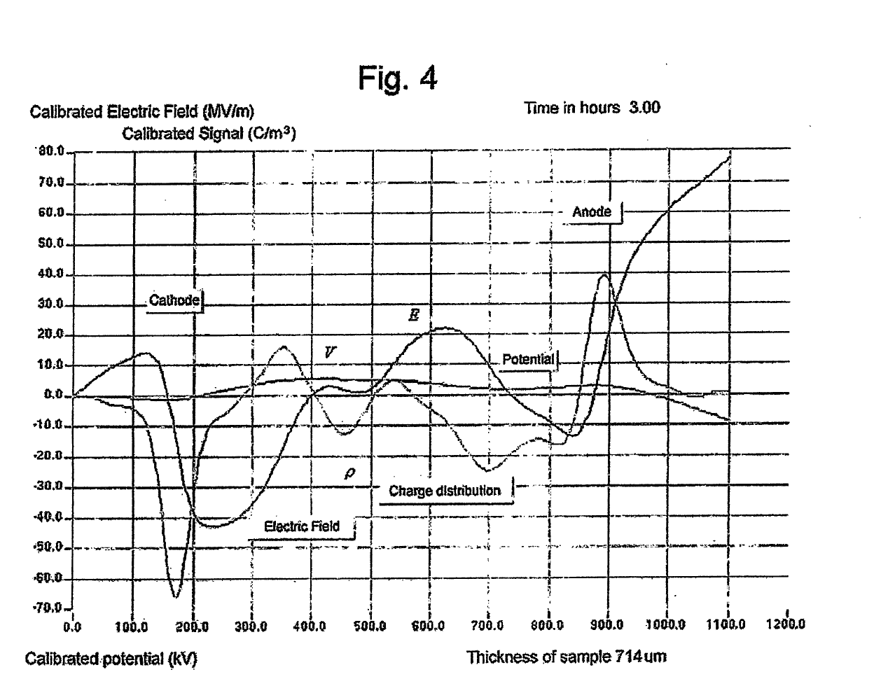

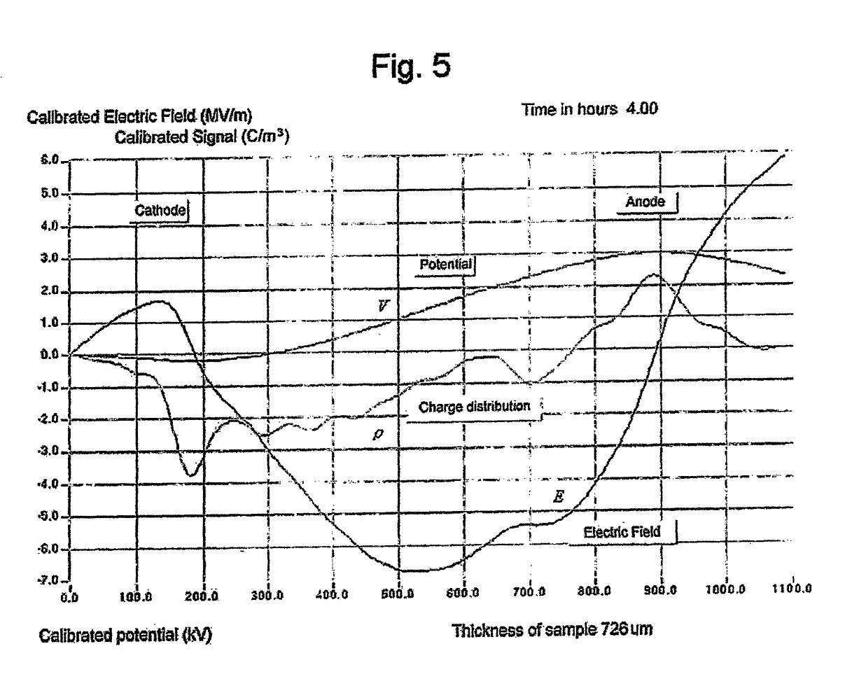

The laminar samples were subjected to direct voltages. According to FIG. 3, the initial distribution of stress shows little deviation from the nominal 4.3 kVmm⁻¹ uniform level across the bulk. However, characteristic results are shown in FIGS. 4 and 5 for the micro- and nano-materials (10% loading) respectively after several hours of stressing. These plots show the charge, potential and field distributions, for a 3 kV steady DC field applied. The 1.5 μm filler generates substantial internal charge, in marked contrast to the nano-material which behaves in a similar way to the base resin.

FIG. 4 shows several distinctive features including (a) heterocharge accumulation of both signs leading to steep internal charge gradients; (b) a cathode field augmented to over 40 kVmm⁻¹ (10× the nominal value); and (c) field reversal yielding a point of zero stress which will greatly complicate charge transport.

Transient PEA studies permit the establishment and decay of charge profiles to be viewed in time.

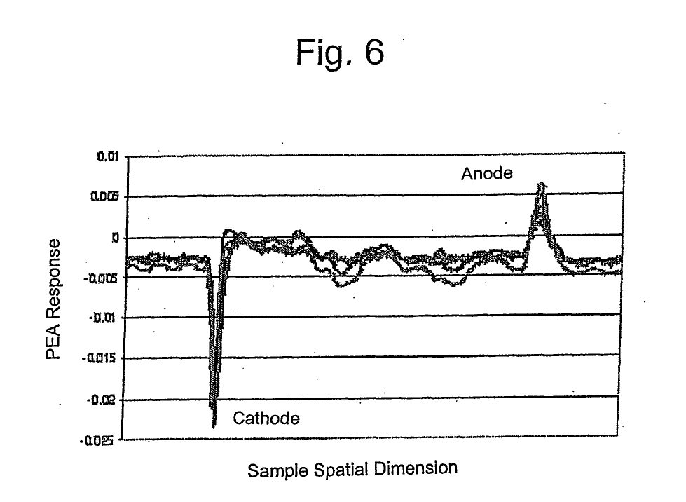

Measurements, such as that depicted in FIG. 6 for a step voltage application of 3 kV on a 10% micro-filled specimen, indicate that increases in the size of the charge peaks occurs over a 4 hour period with little macroscopic change to the complex internal distribution. The stable stationary positioning of these peaks may be due to the interaction of space charge with local polarization to create a self-compensating situation.

However, there are very substantial differences in the time constants associated with the migration and decay of charge for the micro-and nano-composites as is illustrated below in Table 3 in comparison with optical electroluminescence emission. In contrast to the micro-filled material, the decay of charge in the nano-filled TiO₂ is very rapid with insignificant homocharge remaining after just 2 minutes. Although there is some injection of negative charge at the cathode, the nano-filled material is characterized by much less transport perhaps brought about by the larger density of shallower traps.

TABLE 3

| | 38 nm TiO₂ | 1.5 μm TiO₂ |
|---|---|---|
| Charge Decay (s) | 22 | 1800 |
| Light Decay (s) | <60 | 1200 |

Electroluminescence

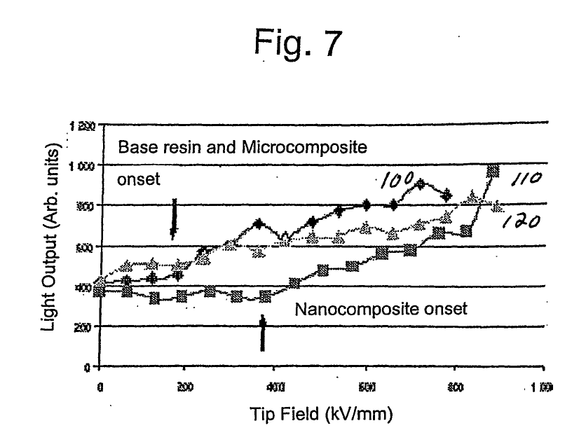

The light emission from a ˜4 μm point molded into the resin samples is depicted in FIG. 7 for a 10% loading. The curves 100, 110, and 120 rexspectively represent the base resin sample, the 10% micro filler resin sample, and the 10% nano filler resin sample. The pre-discharge electroluminescence is measured with a 13-dynode EMI 9789B photomultiplier tube having a bialkali spectral response connected in scintillation counting mode (i.e. the light is determined by counting pulses during a fixed interval, usually 60 s). Two hours was allowed for the photocathode to stabilize before measurements were attempted. The field, E, in FIG. 7 is that calculated at the individual tip based on J. H. Mason, “Breakdown of solids in divergent fields” Proc. IEE Vol. 102C, 1955, pp 254-63:

$$E = \frac{2 V}{r ln ( 4 d / r )} \qquad ( 1 )$$

where r is the tip radius and d the inter-electrode gap.

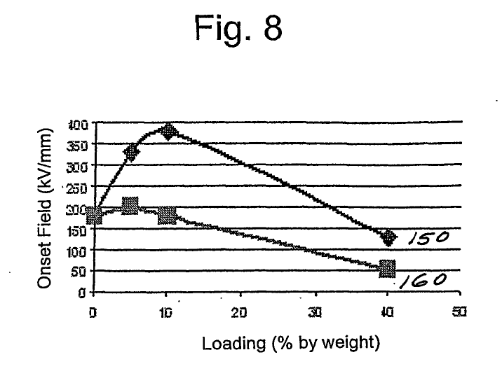

While the level of activity for the nanomaterial is generally somewhat less, the salient feature is the light onset level. The nanomaterial requires 400 kVmm⁻¹ to register output above the background count whereas both the base resin and the micromaterial start emitting at stresses which are only half that value -about 180 kVmm⁻¹. This compares with the 178 kV mm⁻¹ found by V. Griseri et al. “Electroluminescence excitation mechanisms in an epoxy resin under divergent and uniform field” Trans IEEE, Vol. DEI-9, 2002, pp 150-60, using uniform fields in a similar resin system. However, this comparison may be fortuitous since the previous study speculated that the emission is the result of a bipolar charge recombination mechanism. In this divergent field case, it is more likely that the light results from the downward transition of excited species formed by electron injection in the high tip field. When the electroluminescence output is examined as a function of loading (FIG. 8), it is clear that enhancement in the onset is again a maximum at about 10% as is indicated below in the section entitled Electric Strength. In FIG. 8, electroluminescence onset field is plotted as a function of sample loading for the 38 nm sample and 1.5 μm sample plotted respectively as curves 150 and 160.

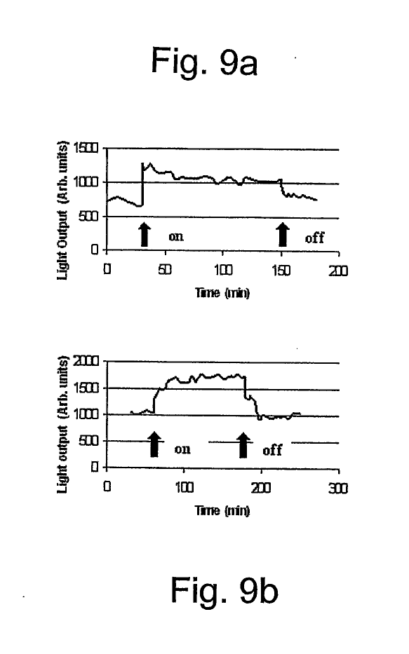

Electroluminescence measurements have also been made as a function of time to observe the way in which the materials react to a step change in stress of 600 kVmm⁻¹. FIGS. 9a and 9b depict the dynamics of light emission for 10% nano- and micro-filled materials respectively. The time response of the base resin is of the same form as shown in FIG. 9a for the nanocomposite. Comparison of these under both switch-on and switch-off transients indicate that the two materials respond very differently as will be discussed at greater length later. However, it is also important to recognize that light is emitted for a period after the applied field is removed, strongly suggesting that it is the Poisson and not the Laplacian field that is intimately involved with electroluminescence.

Thermally Stimulated Currents

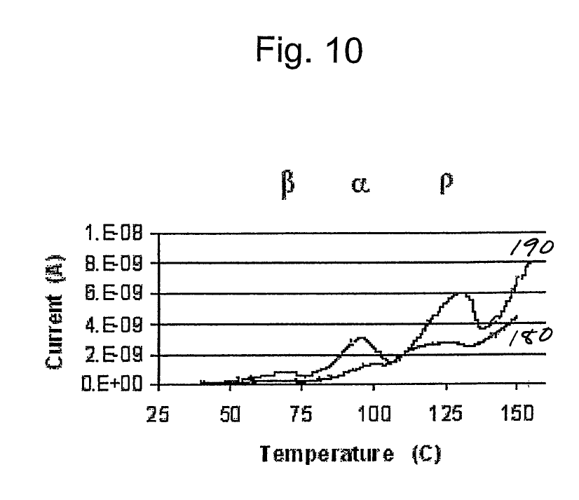

Laminar samples of both micro- and nano-filled resin were subjected to thermally stimulated discharge having been poled at 115° C. at a stress of 55 kvcm⁻¹. The temperature ramp rate was 0.05° Cs⁻¹. Typical plots for the two different types of material are shown in FIG. 10, where curve 180 represents 10% 38 nm TiO₂ and curve 190 represents 10% 1.5 um TiO₂ fillers.

The glass transition temperature, T_{g} for the base resin is 89° C., and Differential Scanning Calorimetery measurements have already demonstrated that T_{g} can be expected to change slightly with the TiO₂ filler size for this resin. Accordingly, the TSC peaks at about 90° C. may be associated the main chain relaxation (the α-peak). Similarly, the peak at about 70° C. can be associated with the β-relaxation. However, the characteristics above 100° C. are very different indeed for the two filler sizes. This region, designated as the ρ peak shown in FIG. 10, is due to the release of space charge in epoxy resins as identified by A Kawamoto et al., “Effects of interface on electrical conduction in epoxy resin composites”, Proc. 3^{rd} Int. conf. on Prop. & App. of Diel. Mats., IEEE, 1991, pp 619-22.

Electrical Strength Measurements

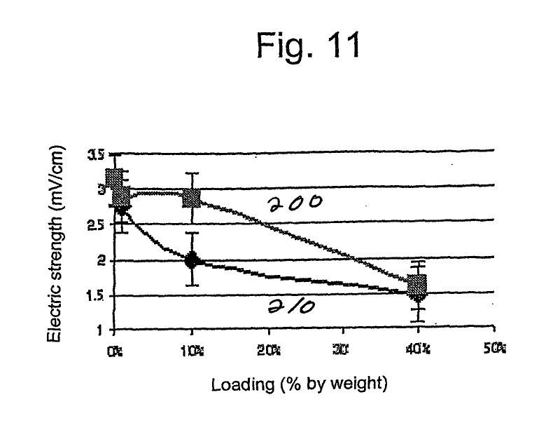

Short-term electric strength measurements have been measured under DC conditions with a ramp rate of 500 Vs⁻¹. FIG. 11 depicts the mean breakdown gradient (for a population of 10 samples) for the base resin, as well as the micro- and nano-composites as a function of filler loading (% by weight). Curve 200 represents the 38 nm sample and curve 210 represents the 1.5 μm sample. The advantage in electric strength attributable to the nano-sized filler is clear, and an optimum loading of about 10% is indicated. Although, for high loadings (close to the percolation limit), the advantages are eroded, and the degradation in mechanical properties makes such very high loadings unattractive.

In summary, very marked differences in charge accumulation are seen in filled materials depending on whether the filler has micron or nanometric dimensions.

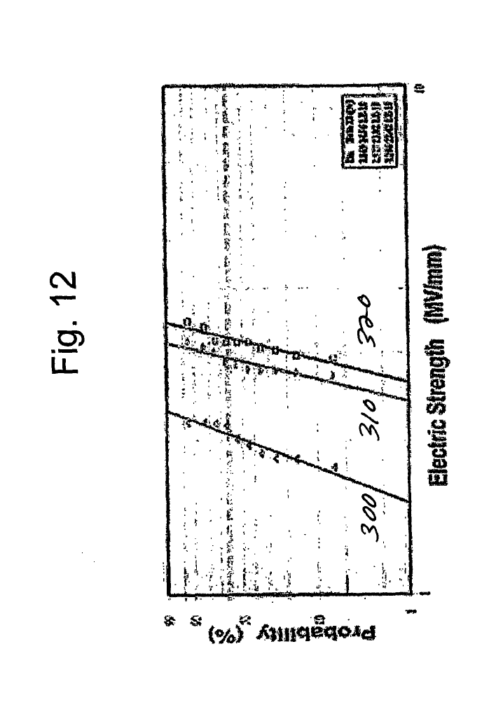

Not only does the incorporation of nanoparticles yield a dielectric strength close to that of the base polymer, but FIG. 11 also demonstrates that the β parameter (dispersion) is unchanged by the addition, in contrast to the microfilled material where a significant change of slope in the Weibull plot in FIG. 12 is indicated. FIG. 12 shows a graph of composite breakdown statistics plotted as a Weibull distribution where line 300 represents micro filler resin, line 310 represents nano filler resin, and line 320 represents base resin. While the presumed reduction of free volume on the substitution of nanoparticles may be instrumental in improving the electric strength as disclosed by Kawamoto et al. above, the results presented here also strongly suggest that the improvements in electric strength may be linked to the control of the internal charge within the bulk.

The electroluminescence onset studies reported here suggest that the large surface area inherent nanoparticles has created a mechanism for electron scattering which will skew the energy distribution with beneficial results; i.e. a higher voltage is required for light onset. However, in seeking reasons for the marked differences seen in many aspects of behavior when nanoparticulates are incorporated, FIGS. 9a and 9b would seem to be pivotal. The escalation of light in micro-filled resin over a period of about an hour following energization suggests that the tip field is augmented by the establishment of heterocharge (positive) in front of the point cathode. Indeed, the emission of light following the removal of the applied stress dictates that the tip field is sustained by charge in the bulk.

Careful examination of the PEA results indicates that such a region of charge is, indeed, formed when the infilled material is of large (μm) dimension. In contrast, the nanomaterial exhibits the maximum electroluminescence on switch-on, indicating that any charge which accumulated acts to shield the point electrode and reduce the high-field light emission. This effect will also be incorporated in FIG. 7 since there was sufficient time allowed for charge modification to take place. Although not shown in FIG. 7, cases were documented where the onset of light occurred measurably earlier for the micro-filled material than for the base resin.

The PEA method also allows the decay of charge to be estimated following the removal of the applied field. Table 3 above provides estimates of the decay time constants obtained from the decay of the electrode image charges in a PEA experiment for TiO₂ nano- and micro-filled epoxy in comparison with electroluminescence decay. While the absolute numbers are not comparable because of the differing geometries, nevertheless, the very substantial differences brought about by the filler size are demonstrated by both techniques and, again, points to the effects of internal fields.

Charges trapped at the interfaces formed by the microparticles will be neutralized by charges of opposite sign conveyed to the interfaces by ohmic conduction giving rise to a TSC transient. This means that the nature of the TSC peak (and even its polarity) will depend on both the relative permittivity and the conductivity of the constituent materials. Following the work of J. van Turnhout in “Electrets”, Chapter 3, Springer-Verlag, 1980, (Topics in Applied Physics, Vol. 33 ed. G. M. Seessler), the TSC transient due to the annihilation of charge, σ, is given by:

$$i ( t ) = \frac{ⅆ σ}{ⅆ t} \frac{[ ɛ / {ɛ}_{1} - g ( T ) / {g}_{1} ( T ) ]}{[ s / {s}_{1} + g ( T ) / {g}_{1} ( T ) ] ( 1 + ɛ {s}_{1} / {e}_{1} s )} \qquad ( 2 )$$

where the ratios of the permittivities ε/ε₁ and the conductivities g/g₁ will determine the polarity of the discharge current during the TSC thermal ramp.

Consequently, for microfilled TiO₂, a negative Maxwell-Wagner peak is sometimes experienced, particulary at low poling temperatures. However, the poling temperature used in FIG. 10 (115° C.) is above T_{g} and thus the ρ-peak should be fully developed as disclosed by J. van Turnhout, and the position of the peak is independent of the poling conditions as has been found in this study. The significant finding here is that the nano-composite does not exhibit the marked ρ-peak characteristic of Maxwell-Wagner interfacial effects in the conventional material.

The PEA results taken in conjunction with the Dielectric Spectroscopy and DSC studies suggest that significant interfacial polarization is implied for conventional fillers which is mitigated in the case of particulates of nanometric size, where a short-range highly immobilized layer develops near the surface of the nanofiller (1-2 nm). This bound layer, however, influences a much larger region surrounding the particle in which conformational behavior and chain kinetics are significantly altered. This interaction zone is responsible for the material property modifications especially as the curvature of the particles approaches the chain conformation length of the polymer.

Evidence suggests that the local chain conformation and configuration play major roles in determining the interactions of a polymer with nanofillers, as is evidenced here by the DSC results of Table 1. The polymer binding to the nanoparticles replaces some of the cross-linking and thus loosens the structure. In contrast, the micron scale case produces significant Maxwell-Wagner polarization giving rise to the characteristics of FIG. 4.

In the case of nanofillers, there is evidence that a grafted layer is formed by the absorption of endfunctionalised polymers onto the surface especially when the functional groups are distributed uniformly along the polymer backbone. Hence the local chain conformation is critical to determining the way in which bonding takes place (and thus the cohesive energy density). The defective nature of nanoscale particles can be expected to enhance the bonding if chemical coupling agents (CVD coatings on nanoparticles or triblock copolymers) are employed.

The present invention has a variety of applications. For example, in terms of volume, one of the most significant applications of the present invention is in the field of power generators and motor insulation. Epoxy mica, which is discharge resistant, currently has an insulative life of approximately 10 years and is ideal for the field of power generators and motor insulation. Pacemakers are another suitable application of the present invention because the present invention allows insulator suppliers/manufacturers to increase voltage and reduce size of insulative materials since less material is required.

Finally, it is anticipated that the use of smaller molecules as synthetic additives, chemical coupling agents, triblock copolymers, etc. may permit an element of self assembly of these structures, and create a class of “smart” materials based on nanocomposites to provide auto stress relief and other forms of self compensation. It may be possible to self-assemble nanodielectrics by providing chemical structures with “hooks” which provide preferential attachment points for the nanostructured materials allowing automatic and predictable self assembly.

While a specific embodiment of the invention has been shown and described in detail to illustrate the application of the principles of the invention, it will be understood that the invention may be embodied otherwise without departing from such principles.

1. A nanometric composite for use in dielectric structures to reduce interfacial polarization, comprising:
a matrix of polymer; and
nano-particulate fillers;
wherein internal charge is modified.

2. A nanometric composite according to claim 1, wherein the polymer is selected from the group consisting of epoxy, polyolefin, ethylene propylene rubber and polyetherimide.

3. A nanometric composite according to claim 1, wherein the filler is selected from the group consisting of inorganic oxides, metal oxides, titanates, silicas, particles coated with coupling agents, and nano-sized polymers.

4. A nanometric composite according to claim 1, wherein particulate size is comparable to polymer chain length so that the particulate and the matrix polymer interact cooperatively.

5. A nanometric composite according to claim 1, wherein the composite has a filler loading of 10%.

6. A nanometric composite for use in dielectric structures to reduce interfacial polarization, comprising:
a matrix of thermoset polymer; and
nano-particulate fillers;
wherein particulate size is comparable to polymer chain length so that the particulate and the matrix polymer interact cooperatively so that internal charge is modified.

7. A nanometric composite according to claim 6, wherein the polymer is selected from the group consisting of epoxy, polyolefin, ethylene propylene rubber and polyetherimide.

8. A nanometric composite according to claim 6, wherein the filler is selected from the group consisting of inorganic oxides, metal oxides, titanates, silicas, particles coated with coupling agents, and nano-sized polymers.

9. A nanometric composite according to claim 6, wherein the composite has a filler loading of 10%.

10. A dielectric structure comprising a nanometric composite comprising:
a matrix of polymer; and
nano- particulate fillers;
wherein internal charge is modified.

11. A dielectric structure according to claim 10, wherein the polymer is selected from the group consisting of epoxy, polyolefin, ethylene propylene rubber and polyetherimide.

12. A dielectric structure according to claim 10, wherein the filler is selected from the group consisting of inorganic oxides, metal oxides, titanates, silicas, particles coated with coupling agents, and nano-sized polymers.

13. A dielectric structure according to claim 10, wherein particulate size is comparable to polymer chain length so that the particulate and the matrix polymer interact cooperatively.

14. A dielectric structure according to claim 10, wherein the composite has a filler loading of about 2% to about 20%.

15. A dielectric structure according to claim 10, wherein the composite has a filler loading of about 10%.

16. A dielectric structure according to claim 12, wherein the composite comprising a nano-size polymer has a filler loading ranging from about 2% to about 40%.
